(19) United States
(12) Patent Application Publication
(10) Pub. No.: US 2026/0223229 A1
(43) Pub. Date: Jul. 30, 2026

(54) ELECTRONIC DEVICE, CONTROL METHOD FOR THE SAME AND STORAGE MEDIUM

(71) Applicant: CANON KABUSHIKI KAISHA, Tokyo (JP)

(72) Inventor: TSUBASA HIRANO, Kanagawa (JP)

(21) Appl. No.: 19/629,990

(22) Filed: Mar. 26, 2026

Related U.S. Application Data
(63) Continuation of application No. PCT/JP2024/033075, filed on Sep. 17, 2024.

(30) Foreign Application Priority Data
Sep. 29, 2023 (JP) 2023-170867

(51) Int. Cl. H04W 76/18; H04W 36/08

(52) U.S. Cl. CPC H04W 76/18; H04W 36/08

(57) ABSTRACT

An electronic device includes a change unit configured to change a connection destination from a currently connected access point (AP) to another AP based on a change request; a recording control unit configured to control to record, in storage unit, first information that is information for connecting to a first AP set in advance without dependence on the change request, and second information that is information for connecting to a second AP based on the change request; and a control unit configured to, if control for connecting to the first AP is performed and connection to the first AP fails, refraining from performing control to connect to another AP, and if connection to an AP that is a connection destination based on the change request fails, performing control to connect to the first AP using the first information.

### CROSS-REFERENCE TO RELATED APPLICATIONS

This application is a Continuation of International Patent Application No. PCT/JP2024/033075, filed September 17, 2024, which claims the benefit of Japanese Patent Application No. 2023-170867, filed September 29, 2023, both of which are hereby incorporated by reference herein in their entirety.

### BACKGROUND

### Field of the Technology

The present disclosure relates to an electronic device that can be connected via a wireless LAN, a control method for the same, and a storage medium.

### DESCRIPTION OF THE RELATED ART

In a wireless LAN environment where an electronic device is connected, there is a technology in which, in an Extended Service Set (ESS) constituted by a plurality of Access Points (APs), a connection-destination AP is dynamically switched in order to efficiently exchange data between the APs and a Station (STA). If it is determined that the connection-destination AP is to be switched based on the congestion of the AP to which the STA is connected, the availability of other APs, radio wave conditions, and the like, the currently connected AP transmits a connected AP change request to the STA. When the STA receives an AP change request, it can connect to an appropriate AP by switching the connection-destination AP in accordance with the request.

Japanese Patent Laid-Open No. 2021-175068 discloses the following as processing in which a router having an AP function requests a currently connected wireless client to change its connection destination. A mobile router (MR1) that can connect to a plurality of wireless clients checks whether the wireless client terminals support IEEE 802.11v. It is possible to determine whether or not a wireless client supports IEEE 802.11v from an Association Request frame that the wireless client transmits when wirelessly connecting to the MR1. If a wireless client terminal supports IEEE 802.11v, a BSS Transition Management (BTM) Request frame is transmitted to the corresponding wireless client terminal. A BSS Transition Candidate List Entries field of the BTM Request frame specifies a BSSID of a parent router RT2 as the connection destination. This prompts switching of the connection destination of the client terminal, and the wireless client terminal switches the connection destination from the MR1 to the RT2 in accordance with the received BTM Request frame.

However, if an STA fails to connect to an AP, it may become unconnected and be unable to communicate. Thus, it is necessary to improve the convenience when an STA connects to an AP.

### SUMMARY

According to the present disclosure, there is provided an electronic device comprising: at least one memory and at least one processor which function as: a change unit configured to perform control to change a connection destination from a currently connected access point to another access point based on a change request to change an access point serving as a connection destination, the change request being received from the currently connected access point; a record control unit configured to perform control to record, in storage unit, first connection information that is information for connecting to a first access point set in advance without dependence on the change request, and second connection information that is information for connecting to a second access point based on the change request; and a control unit configured to, if control for connecting to the first access point is performed and connection to the first access point fails, refraining from performing control to connect to another access point, and if connection to an access point that is a connection destination based on the change request fails, performing control to connect to the first access point using the first connection information.

Features of the present disclosure will become apparent from the following description of embodiments with reference to the attached drawings.

### BRIEF DESCRIPTION OF THE DRAWINGS

FIG. 1 is a diagram showing a system configuration.

FIG. 2A is a diagram showing a configuration of a multifunction peripheral (MFP).

FIG. 2B is a diagram showing the configuration of the multifunction peripheral (MFP).

FIG. 3A is a diagram showing an operation display unit of the MFP.

FIG. 3B is a diagram showing the operation display unit of the MFP.

FIG. 3C is a diagram showing the operation display unit of the MFP.

FIG. 4A is a diagram showing a configuration of a mobile terminal device.

FIG. 4B is a diagram showing the configuration of the mobile terminal device.

FIG. 5 is a diagram showing a configuration of an access point (AP).

FIG. 6 is a sequence diagram illustrating processing that is based on a connection destination change request from the AP.

FIG. 7A is a flowchart showing an example of processing performed by the MFP when connecting to the AP.

FIG. 7B is a flowchart showing an example of processing performed by the MFP when connecting to the AP.

FIG. 8A is a diagram showing an example of a screen on the operation display unit of the MFP.

FIG. 8B is a diagram showing an example of the screen on the operation display unit of the MFP.

FIG. 9 is a diagram showing an example of the screen on the operation display unit of the MFP.

FIG. 10A is a diagram showing an example of the screen on the operation display unit of the MFP.

FIG. 10B is a diagram showing an example of the screen on the operation display unit of the MFP.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### System Configuration

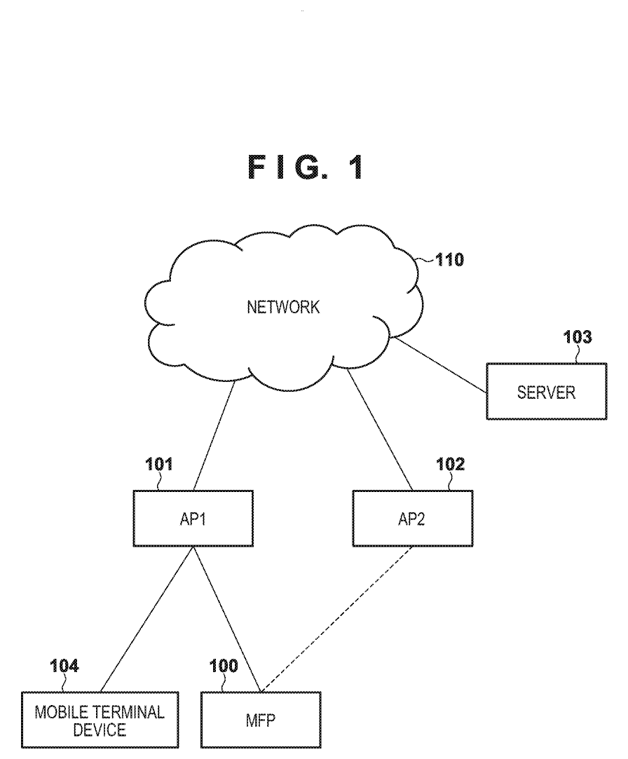

FIG. 1 shows an example of a configuration of a system according to the present embodiment. In one example, the system is a wireless communication system in which a plurality of communication devices can communicate with each other wirelessly. In the example of FIG. 1, the communication devices include a mobile terminal device 104, a multi-function peripheral (MFP) 100, an AP 101 and an AP 102, which are access points, a server 103, and a network 110. Note that the AP 101 and the AP 102 are illustrated as an AP 1 and an AP 2 in some cases. The mobile terminal device 104 is a device having a wireless communication function achieved via a wireless LAN or the like. Note that hereinafter, wireless LAN is referred to as WLAN in some cases. The mobile terminal device 104 can be a personal information terminal such as a Personal Digital Assistant (PDA), a mobile phone (smartphone), a digital camera, a personal computer, or the like.

The MFP 100 has a printing function, and may also have a reading function (scanner), a FAX function, and a telephone function. In addition, the MFP 100 of this embodiment has a communication function that enables wireless communication with the mobile terminal device 104. In addition, in this embodiment, a case where the MFP 100 is used will be described as an example, but there is no limitation to this. For example, a printing device, a scanner device, a projector, a mobile terminal, a smartphone, a notebook PC, a tablet terminal, a PDA, a digital camera, a music playback device, a television, a smart speaker, or the like, each of which has a communication function, may be used instead of the MFP 100. Note that MFP is an acronym for Multi Function Peripheral.

The AP 101 is provided separately (externally) from the mobile terminal device 104 and the MFP 100, and operates as a base station device of the WLAN. A communication device having a WLAN communication function can communicate via the AP 101 in a WLAN infrastructure mode. Note that hereinafter, an access point is referred to as an “AP” in some cases. In addition, the infrastructure mode is called a “wireless infrastructure mode” in some cases. The AP 101 performs wireless communication with a communication device that has been allowed to connect to the AP 101 (a communication device that has been authenticated), and relays wireless communication between that communication device and another communication device. The AP 101 can also be connected to, for example, a wired communication network, and can relay communication between a communication device connected to the wired communication network and another communication device wirelessly connected to the AP 101.

The AP 102 has the same functions as the AP 101, and the MFP 100 switches the connection from the AP 101 to the AP 102 as needed. The server 103 includes a DHCP server and a DNS server. The DHCP server connects to the MFP 100 via the AP 101 and the network 110 and provides a service to the MFP 100 by responding to a request from the MFP 100. Note that in FIG. 1, the DHCP server is illustrated as being connected as a separate device from the AP 101 and the AP 102, but the AP 101 and the AP 102 may also include a DHCP server function. The DNS server is connected to the MFP 100 and the mobile terminal device 104 via the AP 101 and the network 110, and provides a service for name resolution by responding to requests from the MFP 100 and the mobile terminal device 104. Here, the network 110 may be what is called the Internet, or may be a closed network within a company or a mobile phone network.

### External Configuration of MFP

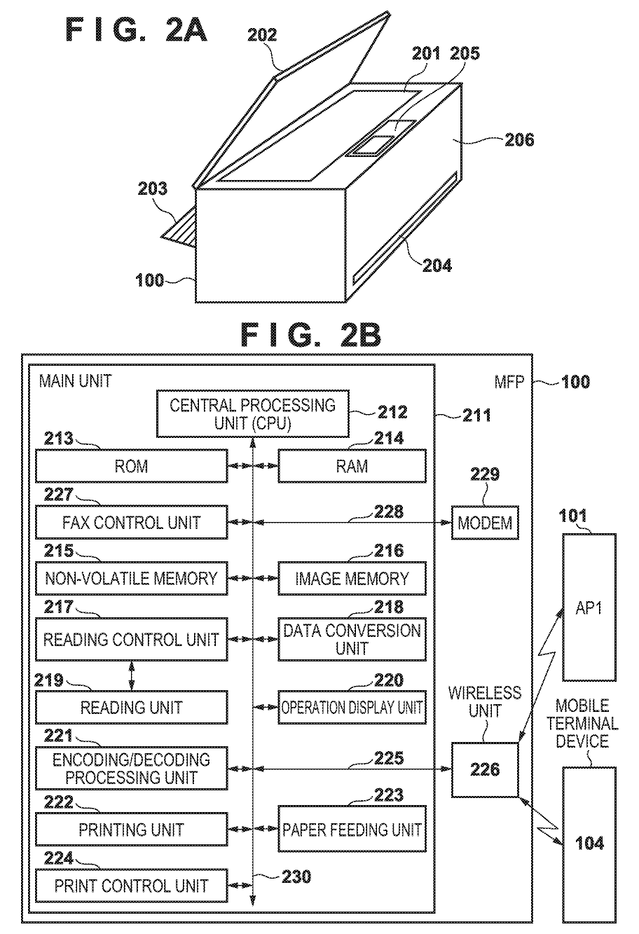

FIG. 2A shows an example of an external configuration of the MFP 100. The MFP 100 includes, for example, a document table 201, a document cover 202, a print sheet insertion port 203, a print sheet ejection port 204, and an operation display unit 205. The document table 201 is a platform on which a document to be read is placed. The document cover 202 is a cover for holding down the document placed on the document table 201 and for preventing light from a light source with which the document is irradiated during reading from leaking to the outside. The print sheet insertion port 203 is an insertion port into which sheets of various sizes can be set. The print sheet ejection port 204 is an ejection port from which sheets are ejected after printing is complete. The sheets set in the print sheet insertion port 203 are transported one by one to a printing unit, where they are printed on, and then are ejected from the print sheet ejection port 204. The operation display unit 205 includes keys such as character input keys, cursor keys, a decision key, and a cancel key, as well as an LED and an LCD, and is configured to be able to accept user operations to activate various functions as an MFP and to perform various settings. The operation display unit 205 may also include a touch panel display. The MFP 100 has a wireless communication function based on WLAN, and includes a wireless communication antenna 206 for this wireless communication, although this does not necessarily need to be visible from the exterior. Like the mobile terminal device 104, the MFP 100 can also perform wireless communication using a WLAN in the 2.4 GHz and 5 GHz frequency bands.

### Configuration of MFP

FIG. 2B shows an example of a configuration of the MFP 100. The MFP 100 includes a main unit 211 that performs main control of the device itself, and a wireless unit 226, which is a single communication module that performs WLAN communication using at least one common antenna. The MFP 100 also includes a modem 229 for performing wired communication, for example. The main unit 211 is simply a unit that includes functional blocks other than the wireless unit 226 and the modem 229. The main unit 211 includes, for example, a CPU 212 (central processing unit), a ROM 213, a RAM 214, a non-volatile memory 215, an image memory 216, a reading control unit 217, a data conversion unit 218, a reading unit 219, and an encoding/decoding processing unit 221. The main unit 211 also includes, for example, a printing unit 222, a paper feeding unit 223, a print control unit 224, an operation display unit 220, and a FAX control unit 227. These functional units within the main unit 211 are connected to one another via a system bus 230 managed by the CPU 212. In addition, the main unit 211 and the wireless unit 226 are connected to each other via, for example, a dedicated bus 225, and the main unit 211 and the modem 229 are connected to each other via, for example, a bus 228.

The CPU 212 is a system control unit that includes at least one processor, and performs overall control of the MFP 100. In one example, the processing of the MFP 100 described below is realized by the CPU 212 executing a program stored in the ROM 213. Note that dedicated hardware for each process may also be provided. The ROM 213 stores a control program to be executed by the CPU 212, an embedded OS program, and the like. In this embodiment, the CPU 212 executes each control program stored in the ROM 213 under the management of an embedded OS similarly stored in the ROM 213, and thereby performs software control such as scheduling and task switching.

The RAM 214 is constituted by an SRAM or the like. The RAM 214 stores data such as program control variables, setting values registered by the user, and management data for the MFP 100. The RAM 214 can also be used as a buffer for various types of work. The non-volatile memory 215 is constituted by, for example, a memory such as a flash memory, and continues to store data even when the MFP 100 is powered off. The image memory 216 is constituted by a memory such as a DRAM. The image memory 216 stores image data received via the wireless unit 226, image data processed by the encoding/decoding processing unit 221, and the like. Note that the memory configuration of MFP 100 is not limited to the above-described configuration. The data conversion unit 218 performs analysis of data in various formats, conversion of image data into print data, and the like.

The reading control unit 217 controls the reading unit 219 (e.g., a contact image sensor (CIS)) to optically read a document placed on the document table 201. The reading control unit 217 converts an image obtained by optically reading the document into electrical image data (image signals) and outputs the result. At this time, the reading control unit 217 may output the image data after performing various types of image processing such as binarization processing and halftone processing.

The operation display unit 220 is the operation display unit 205 described with reference to FIG. 2A, and executes display on a display based on display control performed by the CPU 212, generation of signals in response to reception of a user operation, and the like.

The encoding/decoding processing unit 221 performs encoding processing and decoding processing on image data (JPEG, PNG, etc.) handled by the MFP 100, as well as scaling processing.

The paper feeding unit 223 holds sheets for printing. The paper feeding unit 223 can supply the set sheets under the control of the print control unit 224. The paper feeding unit 223 may include a plurality of paper feeding units in order to store a plurality of types of sheets in one device, and can control which paper feeding unit to use to perform paper feeding, under the control of the print control unit 224.

The print control unit 224 performs various types of image processing such as smoothing processing, print density correction processing, and color correction processing on the image data to be printed, and outputs the processed image data to the printing unit 222. The printing unit 222 is configured to be able to execute, for example, inkjet printing processing, and ejects ink supplied from an ink tank from a print head to record an image on a recording medium (print medium) such as a sheet. Note that the printing unit 222 may be configured to be able to perform other printing processing such as electrophotographic printing. In addition, the print control unit 224 can periodically read out information from the printing unit 222 and update status information and the like, which is stored in the RAM 214 and includes the remaining amount of ink in the ink tank, the state of the print head, and the like.

The wireless unit 226 is a unit that can provide a WLAN communication function, and can provide the same functions as in the case where the WLAN unit 401 of the mobile terminal device 104 is combined, for example. That is, the wireless unit 226 converts data into packets in accordance with the WLAN standard and transmits the packets to another device, and also restores packets from another external device to the original data and outputs the data to the CPU 212. The wireless unit 226 is capable of communication as a station conforming to the IEEE 802.11 standard series. In particular, the wireless unit 226 is capable of communication as a station conforming to IEEE 802.11a/b/g/n/ac/ax. Hereinafter, a station is referred to as an STA in some cases. The wireless unit 226 is also capable of communication as an STA that supports Wi-Fi Agile Multiband (trademark).

The wireless unit 226 supports IEEE 802.11ax, that is, Wi-Fi 6 (trademark), and can perform processing conforming to IEEE 802.11ax. That is, the MFP 100 is capable of performing either or both of operation (processing) as an STA that supports (conforms to) OFDMA and operation (processing) as an STA that supports (conforms to) TWT. OFDMA stands for Orthogonal Frequency-Division Multiple Access. TWT stands for Target Wake Time. Since TWT is supported, the timing of data communication from the parent device to the STA is adjusted. The wireless unit 226 (MFP 100) that is an STA transitions the communication function to a sleep state when standby for signal reception is not needed. This makes it possible to suppress power consumption. The wireless unit 226 is also compatible with Wi-Fi 6E (trademark). That is, communication in the 6 GHz band (5.925 GHz to 7.125 GHz) is also possible. A band that is subject to Dynamic Frequency Selection (DFS) in the 5 GHz band is not present in the 6 GHz band. For this reason, when communicating in the 6 GHz band, communication interruptions due to DFS waiting times will not occur, and smoother communication can be expected.

Note that the mobile terminal device 104 and the MFP 100 are capable of P2P (WLAN) communication based on WFD, and the wireless unit 226 has a software access point (soft AP) function or a group owner function. That is, the wireless unit 226 can construct a network for P2P communication and determine the channel to be used for P2P communication.

### Operation Display Unit of MFP

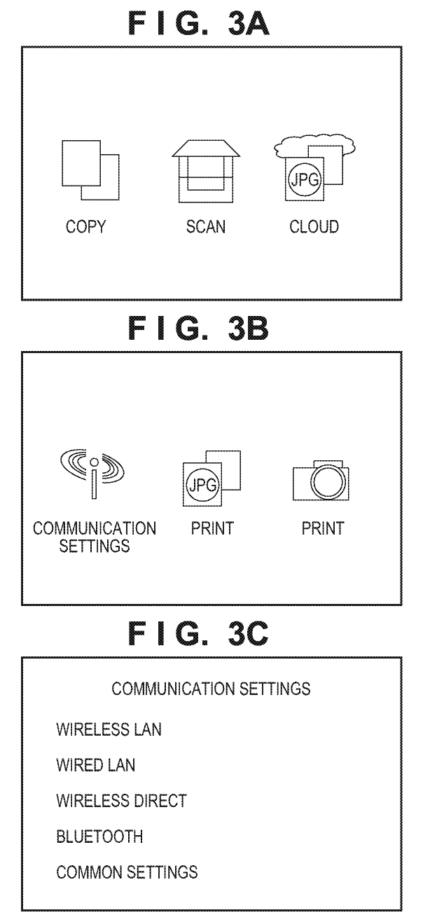

FIGS. 3A and 3B schematically show examples of screen display on a display (touch panel display) included in the operation display unit 220 of the MFP 100. FIG. 3A is an example of a home screen that is displayed when the MFP 100 is powered on and no operation such as printing or scanning is being performed (idle state, standby state). In FIG. 3A, display items (menu items) corresponding to copy, scan, and cloud are displayed. Cloud is a menu item related to a cloud function that uses Internet communication. When any of the menu items is selected through key operation or touch panel operation, the MFP 100 can start to execute the corresponding setting or function. The MFP 100 can seamlessly display a screen different from that shown in FIG. 3A by accepting a key operation or a touch panel operation on the home screen shown in FIG. 3A.

FIG. 3B is an example of display of another portion of the home screen, and is a screen that transitions from the state shown in FIG. 3A due to an operation (a sliding operation to the left or right, etc.) for displaying another page of the home screen. In FIG. 3B, display items (menu items) corresponding to communication settings, printing, and device settings are displayed. When any of these menu items is selected, the function corresponding to the selected menu item, that is, one of a printing function, device settings, and communication settings, is executed.

FIG. 3C is an example of display of a communication settings menu screen that is displayed when communication settings are selected on the screen of FIG. 3B. The communication settings menu screen displays “wireless LAN”, “wired LAN”, “wireless direct”, “Bluetooth”, and “common” as menu items (options). “Wireless LAN”, “wired LAN”, and “wireless direct” are menu items for configuring LAN settings, and from these items, it is possible to configure settings such as settings for a wired connection, settings for enabling/disabling a wireless infrastructure mode, and settings for enabling/disabling a P2P mode such as WFD or soft AP mode. When the “wireless LAN” item is selected and the wireless LAN is enabled through a user operation, the wireless infrastructure mode is enabled. When the “wireless direct” item is selected and wireless direct is enabled through a user operation, the P2P (WLAN) mode is enabled. This screen also displays a common setting menu relating to each connection mode. Furthermore, the user can configure settings such as the frequency band and frequency channel of the wireless LAN from this screen.

### External Configuration of Mobile Terminal Device

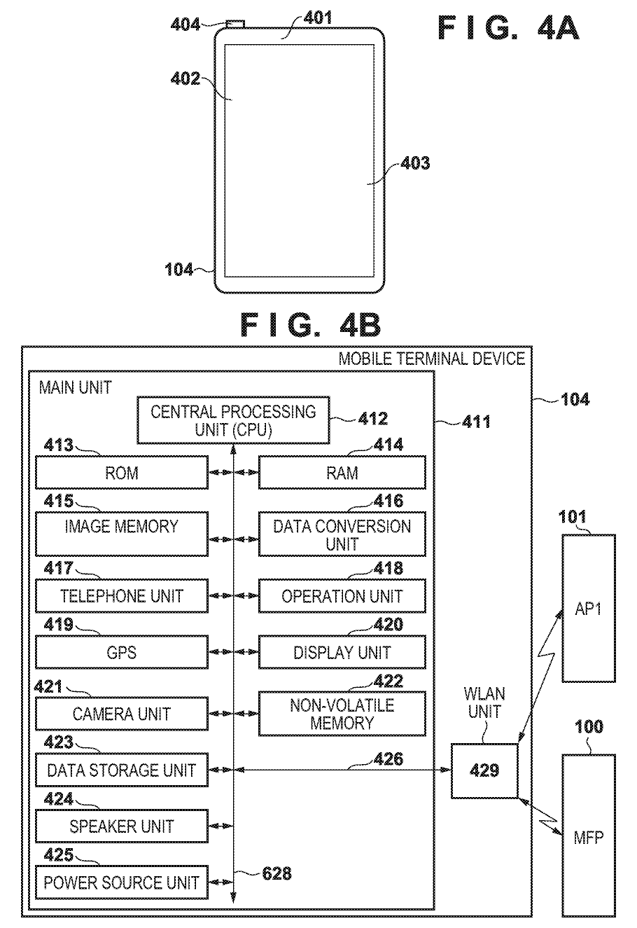

FIG. 4A is a diagram showing an example of an external configuration of the mobile terminal device 104. In this embodiment, as an example, the mobile terminal device 104 is a general type of smartphone. Note that the mobile terminal device 104 includes, for example, a display unit 402, an operation unit 403, and a power key 404. The display unit 402 is, for example, a display including a liquid crystal display (LCD) display mechanism. Note that the display unit 402 may display information using, for example, a light emitting diode (LED) or the like. In addition, the mobile terminal device 104 may also have a function of outputting information by audio in addition to or instead of the display unit 402. The operation unit 403 includes physical keys such as keys and buttons, a touch panel, and the like for detecting user operations. Note that in this example, the display unit 402 displays information and the operation unit 403 accepts user operations using a common touch panel display, and therefore the display unit 402 and the operation unit 403 are realized by one device. In this case, for example, button icons and a software keyboard are displayed using the display function of the display unit 402, and the operation acceptance function of the operation unit 403 detects that the user has touched these locations. Note that the display unit 402 and the operation unit 403 may be separated, and hardware for display and hardware for accepting operations may be provided separately. The power key 404 is a hardware key for accepting a user operation to power on or off the mobile terminal device 104.

The mobile terminal device 104 has a WLAN unit 401 that provides a WLAN communication function, which does not necessarily need to be visible from the outside. The WLAN unit 401 is configured to be able to execute data (packet) communication in a WLAN system conforming to, for example, the IEEE 802.11 standard series (IEEE 802.11a/b/g/n/ac/ax, etc.). It is also capable of communication as an AP that supports Wi-Fi Agile Multiband (trademark). However, there is no limitation to this, and the WLAN unit 401 may also be capable of executing communication in a WLAN system conforming to another standard. Note that in this example, it is assumed that the WLAN unit 401 is capable of communication in both the 2.4 GHz and 5 GHz frequency bands. In addition, the WLAN unit 401 is capable of executing communication based on WFD, communication in the soft AP mode, communication in the wireless infrastructure mode, and the like. Operation in these modes will be described later.

### Configuration of Mobile Terminal Device

FIG. 4B shows an example of a configuration of the mobile terminal device 104. In one example, the mobile terminal device 104 includes a main unit 411 that performs main control of the device itself, and a WLAN unit 429 that performs WLAN communication. The main unit 411 is simply a unit that includes functional blocks other than the WLAN unit 429. The main unit 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power source unit 425. Here, CPU is an acronym for Central Processing Unit, ROM is an acronym for Read Only Memory, RAM is an acronym for Random Access Memory, and GPS is an acronym for Global Positioning System. The mobile terminal device 104 also includes a display unit 420 and an operation unit 418. These functional units within the main unit 411 are connected to one another via a system bus 628 managed by the CPU 412. In addition, the main unit 411 and the WLAN unit 429 (the above-mentioned WLAN unit 401) are connected to each other via a dedicated bus 426, for example.

The CPU 412 is a system control unit that includes at least one processor, and performs overall control of the mobile terminal device 104. In one example, the processing of the mobile terminal device 104 described below is realized by the CPU 412 executing a program stored in the ROM 413. Note that dedicated hardware for each process may also be provided. The ROM 413 stores the control program executed by the CPU 412, an embedded operating system (OS) program, and the like. In this embodiment, the CPU 412 executes each control program stored in the ROM 413 under the management of an embedded OS similarly stored in the ROM 413, and thereby performs software control such as scheduling and task switching.

The RAM 414 is constituted by an SRAM (Static RAM) or the like. The RAM 414 stores data such as program control variables, and data such as setting values registered by the user and management data for the mobile terminal device 104. The RAM 414 can also be used as a buffer for various types of work. The image memory 415 is constituted by a memory such as a DRAM (Dynamic RAM). The image memory 415 temporarily stores image data received via the WLAN unit 429 and image data read out from the data storage unit 423 for processing by the CPU 412. The non-volatile memory 422 is constituted by a memory such as a flash memory, and continues to store data even when the mobile terminal device 104 is powered off. Note that the memory configuration of the mobile terminal device 104 is not limited to the above-described configuration. For example, the image memory 415 and the RAM 414 may be shared, or the data storage unit 423 may be used to back up data or the like. In addition, in this embodiment, a DRAM is given as an example of the image memory 415, but another storage medium such as a hard disk or non-volatile memory may also be used.

The data conversion unit 416 performs analysis of data in various formats and data conversion such as color conversion and image conversion. The telephone unit 417 controls a telephone line and processes audio data input and output via the speaker unit 424, thereby realizing telephone communication. The GPS 419 receives radio waves transmitted from satellites and acquires location information such as the current latitude and longitude of the mobile terminal device 104.

The camera unit 421 has a function of electronically recording and encoding an image input via a lens. Image data obtained by image capture using the camera unit 421 is stored in the data storage unit 423. The speaker unit 424 performs control for realizing a function of inputting or outputting audio for a telephone function, as well as another function such as alarm notification. The power source unit 425 is, for example, a portable battery, and controls the supply of power to the device. The power state includes, for example, a dead battery state in which there is no remaining battery power, a power-off state in which the power key 404 has not been pressed, a running state in which the device is running normally, and a power-saving state in which the device is running but is saving power.

The display unit 420 is the display unit 402 described with reference to FIG. 4A, and performs display of various input operations, the operating status of the MFP 100, and the status, and the like, based on the control of the CPU 412. The operation unit 418 is the operation unit 403 described with reference to FIG. 4A, and upon accepting a user operation, executes control such as generating an electrical signal corresponding to the operation and outputting the result to the CPU 412.

The mobile terminal device 104 performs wireless communication using the WLAN unit 429, and performs data communication with another device such as the MFP 100. The WLAN unit 429 converts data into packets and transmits the packets to the other device. In addition, the WLAN unit 429 restores packets from the other external device to the original data and outputs the original data to the CPU 412. The WLAN unit 429 is a unit for realizing communication conforming to the WLAN standard. The WLAN unit 429 can operate in at least two communication modes in parallel, the communication modes including a wireless infrastructure mode and a P2P (WLAN) mode. Note that the frequency bands used in these communication modes can be limited by the function and performance of the hardware.

### Configuration of Access Point

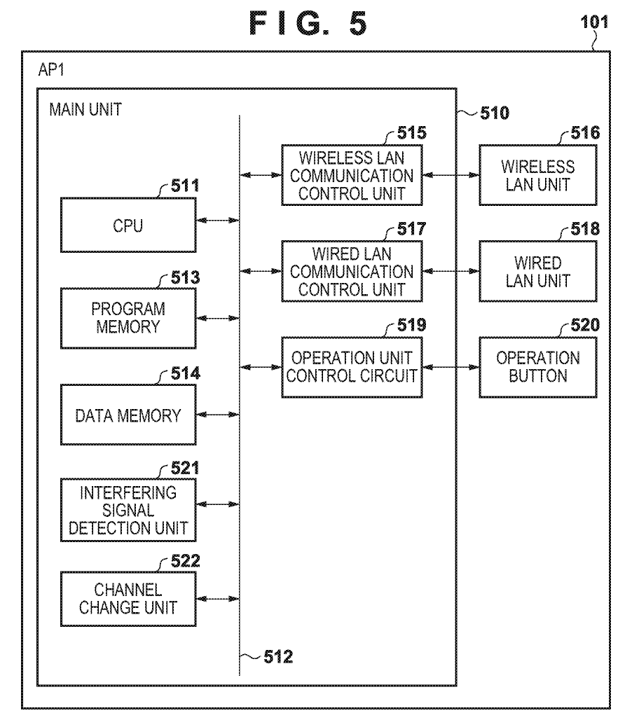

FIG. 5 is a block diagram showing a configuration of the AP 101 having a wireless LAN access point function. The AP 101 includes a main unit 510 that controls the AP 101, a wireless LAN unit 516, a wired LAN unit 518, and an operation button 520. The main unit 510 is a unit that simply includes functional blocks other than the wireless LAN unit 516, the wired LAN unit 518, and the operation button 520.

A CPU 511 in the form of a microprocessor disposed in the main unit 510 operates in accordance with a control program stored in a program memory 513 in the form of a ROM connected via an internal bus 512, and the content of a data memory 514 in the form of a RAM. The CPU 511 controls the wireless LAN unit 516 via a wireless LAN communication control unit 515 to perform wireless LAN communication with another communication terminal device. In addition, the CPU 511 controls the wired LAN unit 518 via a wired LAN communication control unit 517 to perform wired LAN communication with another communication terminal device. The CPU 511 can control an operation unit control circuit 519 to accept an operation from the user via the operation button 520. The CPU 511 includes at least one processor.

The AP 101 also includes an interfering signal detection unit 521 and a channel change unit 522. The interfering signal detection unit 521 performs interfering signal detection processing when wireless communication is being executed in a band where Dynamic Frequency Selection (DFS) is implemented. The channel change unit 522 performs processing for changing the channel to be used when, for example, an interference wave is detected during execution of wireless communication in a band where DFS is implemented, and it is necessary to immediately change to an available channel.

Note that the AP 102 has the same configuration as the AP 101.

### P2P Communication Method

Next, an overview will be provided regarding the P2P (WLAN) communication method by which devices communicate directly with each other wirelessly without going through an external access point in WLAN communication. P2P (WLAN) communication can be realized using a plurality of techniques, and for example, a communication device can support a plurality of modes for P2P (WLAN) communication and selectively use one of the plurality of modes to execute P2P communication (WLAN).

The following two modes are envisioned as P2P modes.

### • Soft AP mode

### • Wi-Fi Direct (WFD) mode

A communication device capable of executing P2P communication can be configured to support at least one of these modes. On the other hand, even a communication device capable of executing P2P communication does not need to support all of these modes, and may be configured to support only some of them.

A communication device (e.g., the mobile terminal device 104) having a WFD communication function accepts a user operation via its operation unit, and calls an application (in some cases, a dedicated application) for realizing the communication function. Then, the communication device displays a UI (user interface) screen provided by the application to prompt a user operation, and can execute WFD communication based on the user operation accepted in response.

### • Soft AP mode

In the soft AP mode, a communication device (e.g., the mobile terminal device 104) operates in the role of a client that requests various services. The other communication device (e.g., the MFP 100) operates as a soft AP that can execute the functions of a WLAN AP through software settings. Note that the commands and parameters transmitted and received when establishing a wireless connection between a client and a soft AP need only be those specified in the Wi-Fi (registered trademark) standard, and therefore description thereof will be omitted here. In addition, the MFP 100 operating in the soft AP mode determines the frequency band and frequency channel as the parent station. For this reason, the MFP 100 can select which frequency band to use from 5 GHz and 2.4 GHz, and can select which frequency channel to use within that frequency band.

### • WFD Mode

The MFP 100 may be configured to be permanently activated as a parent station in the WFD mode (Autonomous Group Owner). In this case, GO Negotiation processing for determining the role is not needed. In this case, the MFP 100 determines the frequency band and frequency channel as the parent station. For this reason, the MFP 100 can select which frequency band to use from 5 GHz and 2.4 GHz, and can select which frequency channel to use within that frequency band.

### Wireless Infrastructure Mode

In the wireless infrastructure mode, communication devices (e.g., the mobile terminal device 104 and the MFP 100) that communicate with each other are connected to an external AP (e.g., the AP 101) that controls the network, and communication between the communication devices is performed via that AP. In other words, communication between communication devices is executed via a network constructed by an external AP. When the mobile terminal device 104 and the MFP 100 each discover the AP 101 and transmit a connection request to the AP 101 to establish a connection, these communication devices can communicate in the wireless infrastructure mode via the AP 101. Note that a plurality of communication devices may be connected to different APs. In this case, data transfer between APs enables communication between communication devices. The commands and parameters transmitted and received during communication between communication devices via an access point need only be those specified in the Wi-Fi standard, and therefore description thereof is omitted here. In this case, the AP 101 determines the frequency band and frequency channel. For this reason, the AP 101 can select which frequency band to use from 5 GHz, 2.4 GHz, and 6 GHz, and can select which frequency channel to use within that frequency band.

### Processing in Response to Connection Destination Change Request from AP to STA

The mobile terminal device 104 and the MFP 100 support a function disclosed as Wi-Fi Agile Multiband (trademark). Wi-Fi Agile Multiband is a feature that enables the optimal environment to be selected according to changing conditions in the Wi-Fi network. Specifically, STAs such as the mobile terminal device 104 and the MFP 100 and APs such as the AP 101 exchange information relating to the network environment using a communication standard in the IEEE 802.11 series. Through this information exchange, an AP can guide an STA to another AP, frequency band, channel, or even another cellular service in some cases if the network is congested.

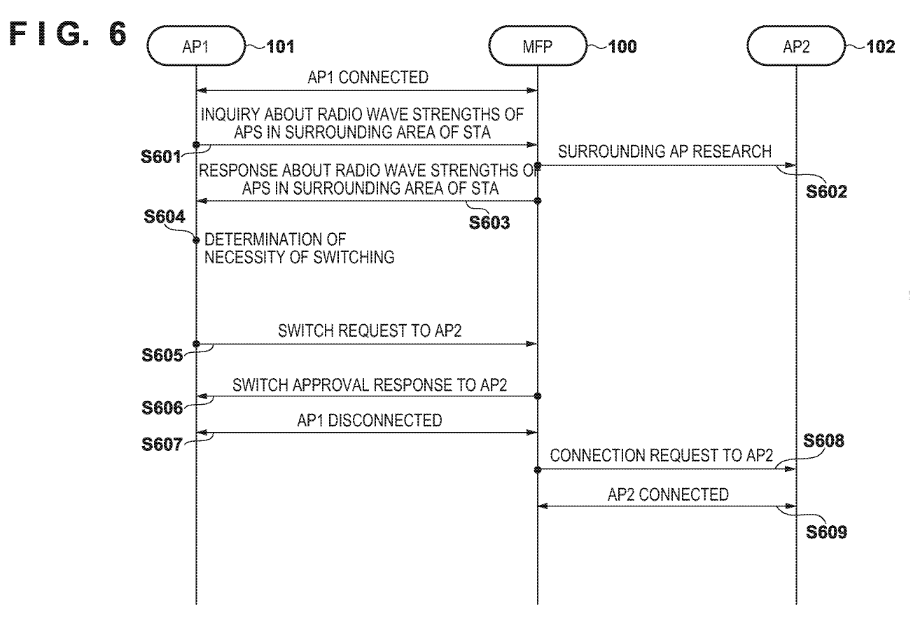

FIG. 6 is a sequence diagram of a case where the MFP 100 switches the connection-destination AP from the AP 101 to the AP 102 in accordance with a connection destination change request from the AP 101. The processing executed by each device in this sequence is realized by the CPU of each device reading out various programs stored in a memory such as a ROM of each device into a RAM and executing the programs.

In the initial state of the processing in FIG. 6, it is assumed that the MFP 100 has established a connection with the AP 101 in the wireless infrastructure mode. In addition, when the MFP 100 and the AP 101 connect in the wireless infrastructure mode, the AP 101 acquires information on whether or not the MFP 100 supports IEEE 802.11v. If the AP 101 has acquired information indicating that the MFP 100 supports IEEE 802.11v, the AP 101 performs the following processing.

In step S601, the AP 101 transmits, to the MFP 100, an inquiry (measurement request) about the radio wave strengths of APs in the surrounding area of the MFP 100. This inquiry is transmitted, for example, as a beacon frame request or a beacon report request. That is, this request can use the mechanism defined in the IEEE 802.11k standard.

In step S602, in response to the request received in step S601, the MFP 100 receives frames transmitted from the APs in the surrounding area and measures the radio wave strengths. As a result, the radio wave strength of each of the plurality of APs, including the AP 101 and the AP 102, is measured.

In step S603, the MFP 100 transmits a list of the radio wave strengths of the APs in the surrounding area of the MFP 100 measured in step S602, as a response to the request received in step S601. Note that the radio wave strengths transmitted as a response may be information stored in the RAM 214 and the non-volatile memory 215 of the MFP 100 in addition to or instead of the information measured in step S602. This response is transmitted, for example, as a beacon report or a measurement report.

In step S604, the AP 101 determines whether or not it is necessary to switch the connection destination of the MFP 100 based on the congestion status in the network that the AP 101 has ascertained and the radio wave strengths received from the MFP 100 in step S603. Factors that cause the AP 101 to determine that a connection switch is necessary include a large number of connected STAs, a large amount of communication, other APs being less congested, the presence or absence of radio interference, and the AP function being stopped. When it is determined that the connection destination of the MFP 100 needs to be switched, and the Service Set Identifier (hereinafter referred to as SSID), channel, and frequency band of another AP that is designated as a switching destination for the MFP 100 are determined, the processing proceeds to step S605.

In step S605, the AP 101 transmits an AP change request (connection destination switch request) to the MFP 100. The connection destination change request includes information on the SSID, channel, and frequency band of another AP that is designated as a switching destination for the MFP 100, as determined in step S604. Note that a plurality of SSIDs may be specified. The connection destination change request is transmitted as, for example, a BTM Request. That is, a BSS Transition Management (BTM) Request frame defined in the IEEE 802.11v standard is transmitted. In the example of FIG. 6, it is assumed that the AP 102 is specified as the switching destination included in the connection destination change request.

In step S606, if the MFP 100 complies with the connection destination change request received in step S605, the MFP 100 transmits a response indicating approval of the switch to the AP 101. If the MFP 100 does not comply with the connection destination change request, a switching refusal may be sent as a response. The response is transmitted as a BTM Response. In the example of FIG. 6, it is assumed that a response indicating approval is transmitted.

In step S607, the AP 101 and the MFP 100 terminate their connection in the wireless infrastructure mode.

In step S608, the MFP 100 transmits a connection request to the AP 102 to connect to the AP 102 designated in the connection destination change request received in step S605.

As a result, in step S609, a connection between the MFP 100 and the AP 102 is established in the wireless infrastructure mode.

With this mechanism, the MFP 100, which is an STA, can change its connection destination from the AP 101 to the AP 102 based on a connection destination change request from the AP 101 to which it was originally connected. The AP 101 and the AP 102 are APs installed at different locations in some cases. That is, through the processing of FIG. 6, the MFP 100 can switch to another AP installed at a different position from the AP to which it was originally connected. In addition, in some cases, the APs support different frequency bands among a plurality of frequency bands (any two or three of the 2.4 GHz band, 5 GHz band, and 6 GHz band) provided by the same device. That is, the processing of FIG. 6 allows the MFP 100 to switch to another frequency band provided by the same device as the AP to which it was originally connected. For example, based on a connection destination change request, the connection destination can be changed to an AP in the 6 GHz band.

Note that in this embodiment, an example will be described in which an AP transmits a measurement request and a connection destination change request in a mechanism conforming to Wi-Fi Agile Multiband and the STA responds to this, but there is no limitation to this. This embodiment is also applicable to cases where an STA transmits a response or changes the connection-destination AP (switches, deletes, or adds the connection-destination AP) in response to a measurement request or a connection destination change request transmitted from an AP using a mechanism different from the above-described example.

There are situations where it is acceptable to change the connection-destination AP based on a connection-destination AP change request transmitted from the currently connected AP, and situations where it is not desirable. In a situation where it is not desirable to change the connection-destination AP based on a change request, one or a combination of the following processes can be performed as processing for suppressing the change of the connection destination in response to the change request. The following processes are processes for preventing changing of the connection-destination AP based on a change request, or processes for making it more difficult to change the connection-destination AP based on a change request.

(Suppression Processing 1) Even if the change request described in step S605 is received, the connection-destination AP is not changed based on the received connection request, and either a response to the change request is not transmitted, or a response indicating refusal of the change request (indicating that the connection-destination AP will not be changed) is transmitted to the currently connected AP. If a response indicating refusal is transmitted, the priority level of changing a connection destination of another STA connected to the AP currently connected to the MFP 100 will increase, and the priority level of changing the connection destination of the MFP 100 that transmitted the response indicating refusal will decrease, resulting in the MFP 100 being able to maintain its connection to the AP to which it was connected, in some cases. In addition, if no response is given (if the request is ignored), it is thought that the currently connected AP maintains the connection with the MFP 100 in order to wait for a response until a response standby time times out. Accordingly, if the situation was such that the connection would be immediately terminated in response to any response from the MFP 100 to the change request, not responding would enable the connection with the currently connected AP to be maintained for a longer period of time than giving any response. Accordingly, for example, based on information on a reason for change included in the change request, different processing can be performed depending on the reason, such as responding with a refusal if the reason is weak and ignoring if the reason is strong. The reason for the change can be determined based on, for example, information included in the Request Mode included in the BTM Request, the information indicating which of several reasons applies. For example, if a Disassociation Imminent bit or a BSS Termination Included bit in the Request mode is 1, it can be determined that the change request has a strong reason for the change. Otherwise, it can be determined that the reason for the change is weak.

(Suppression Processing 2) Information indicating that the radio wave reception conditions (signal reception conditions) of non-connected APs other than the currently connected AP are worse (poor signal quality) than the actual measured conditions is provided in response to the measurement request described in step S601 (as a false response). In this case, the response may be provided by actually performing measurement in response to receiving the measurement request, or may be provided without actually performing measurement. Specifically, in the response (beacon report, etc.) described in step S603, the received signal strength is reduced and/or the noise (signal-to-noise ratio) is increased relative to the signal quality measured for the signal received from the non-connected AP. Alternatively, the response may not include information on at least one of the non-connected APs. In addition, based on information previously measured regarding the non-connected AP, processing for setting the received signal strength to a significantly low value, or processing for setting the noise to a significantly increased value may be performed. In addition, even if a measurement request is received, a response may be given without actually performing measurement (without actually performing AP search) and without including information about non-connected APs, and the response may indicate that only the currently connected AP has a favorable received signal strength and noise conditions. Responding to a measurement request without including information on non-connected APs corresponds to indicating that no other non-connected APs are found even when an AP search is performed. That is, responding without including information on non-connected APs indicates that at least some of the signal qualities from non-connected APs are worse than in the case when an actual AP search is performed. By doing so, it is expected that a request to change the connection destination from the currently connected AP to another AP will be suppressed. Accordingly, a change of the connection destination in response to a connection destination change request is suppressed.

(Suppression Processing 3) The currently connected AP is temporarily disconnected, notification of information indicating that the change request is not supported is performed, and then the AP is reconnected. Specifically, the wireless connection with the currently connected AP is temporarily disconnected, and then, in preparation for reconnecting wirelessly, Association Request frame data is created which includes information indicating that the AP does not support IEEE 802.11v. Thereafter, the data in the created Association Request frame is used to perform connection processing with the AP. As a result, if an Association Request frame is created that includes information indicating that IEEE 802.11v is not supported, the AP will be connected to as an electronic device that does not support (is incompatible with) the Agile Multiband function. As a result, the currently connected AP recognizes that the MFP 100 does not support IEEE 802.11v, and stops transmitting a wireless connection destination change request to the MFP 100. In this way, the MFP 100 is no longer requested to change the wireless connection, and the wireless connection between the MFP 100 and the currently connected AP is more likely to be maintained. In addition, if the currently connected AP recognizes that the MFP 100 does not support IEEE 802.11v, transmission of a measurement request (the request described in step S601) from the currently connected AP to the MFP 100 is also suppressed. Accordingly, it is possible to suppress measurement (AP search) in response to a measurement request in the MFP 100 and a response to a measurement request (processing of step S603). This can reduce the processing load and power consumption, allowing resources to be allocated to other processing.

A state in which it is not desirable to change the connection-destination AP based on a change request is, for example, when print data is being received. While the MFP 100 is receiving print data, a portion of the print data for the image to be printed has already been received from the mobile terminal device 104, which is a counterpart device, and reception of the remaining portion of the print data has not been completed. The MFP 100 does not store all of the print data to be printed on one sheet. For this reason, the MFP 100 performs printing by repeating a process in which, when a portion of the print data is received, only the received portion is printed (e.g., one line is received and printed), and when subsequent data is received, only the received portion is printed again. When the connection-destination AP is changed based on a connection destination change request while this print data is being received, a time lag occurs accompanying the connection destination switching processing, which may lead to a decrease in print quality, such as uneven printing. In addition, after switching the connection destination, communication with the mobile terminal device 104, which is the counterpart device, may not go well, and the subsequent data may not be received, resulting in a printing failure. Accordingly, while receiving print data, it is preferable to perform at least one of the above-mentioned (Suppression Processing 1) and (Suppression Processing 2) as processing for suppressing change of the connection destination in response to a change request, or to perform the above-mentioned (Suppression Processing 3) before starting to receive print data.

Incidentally, when the MFP 100 receives a connection destination change request from the currently connected AP as described above, the MFP 100 may perform control to switch the connection-destination AP based on the change request. On the other hand, the MFP 100 may fail to connect to the AP based on the change request. If the MFP 100 fails to connect to the AP, it may become unconnected.

In this embodiment, the MFP 100 receives a request from the currently connected AP to change the connection destination to another AP. The MFP 100 performs recording control in which control is performed to store the connection information of the pre-set AP and the connection information of the other AP included in the change request. The MFP 100 controls the connection-destination AP so as to change the connection from the currently connected AP to another AP based on a connection destination change request. If the MFP 100 fails to change the connection from the currently connected AP to another AP, the MFP 100 uses connection information of a pre-set AP to perform control so as to reconnect to the originally connected AP. With this configuration, even if the MFP 100 fails to connect, it is possible to prevent the MFP 100 from becoming unconnected. Accordingly, it is possible to improve the convenience when connecting the MFP 100 to the AP.

The following describes operation in the case where the MFP 100 changes the connection-destination AP using the Agile Multiband function, and operation in the case of changing the AP according to user settings. The operation in the case of connecting to the AP when the MFP 100 is started up will also be described. In the following description, the operation of the MFP 100 to receive a connection destination change request from the currently connected AP and change the connection-destination AP based on the change request is referred to as an Agile Multiband function in some cases.

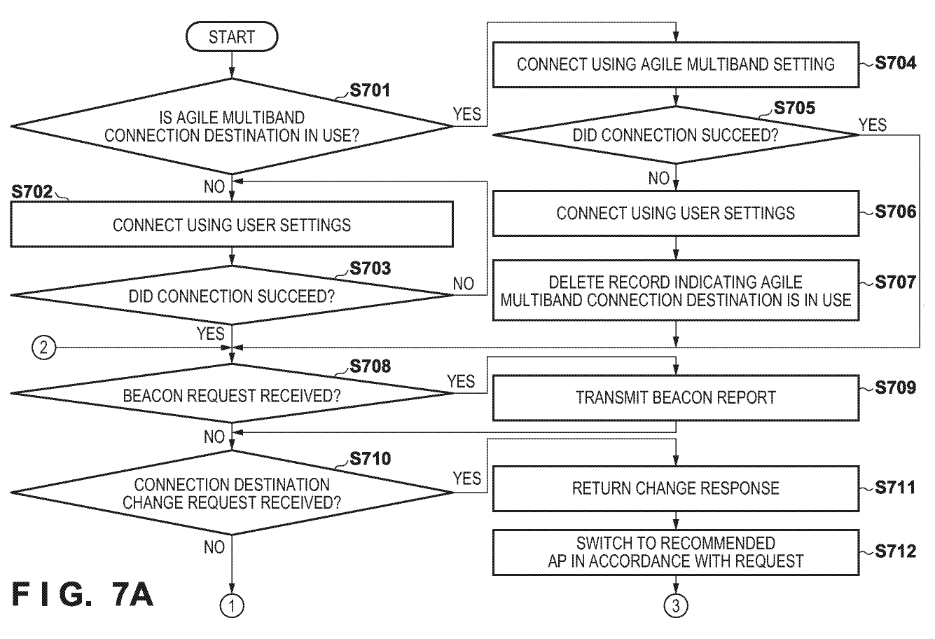

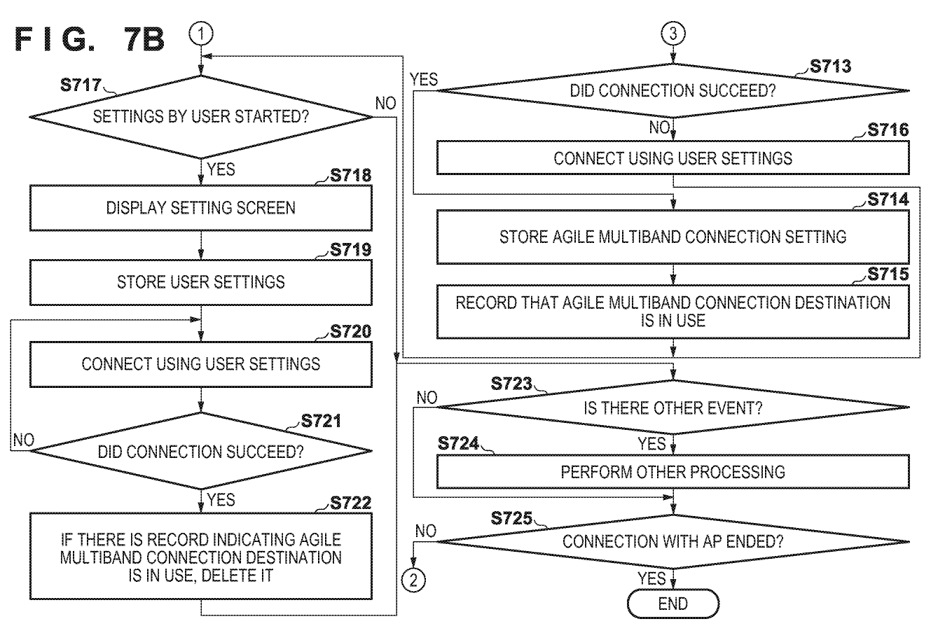

FIGS. 7A and 7B are flowcharts showing an example of the operation of the MFP 100 in this embodiment regarding connection with an AP (e.g., a wireless LAN). In this flowchart, the processing executed by the MFP 100 is realized by the CPU 212 reading out various programs stored in a memory such as the ROM 213 into the RAM 214 and executing them. FIGS. 7A and 7B are started when, for example, the MFP 100 is powered on. That is, the processing in FIGS. 7A and 7B is started, for example, when the MFP is restarted.

The processing of steps S701 to S707 shows an example of an operation of connecting to the AP that is executed when the MFP 100 is powered on, for example. The processing of step S708 and onward represents an example of an operation that is executed after the MFP 100 connects to the AP.

In step S701, the CPU 212 determines whether or not the AP in use is an Agile Multiband-set AP. If the CPU 212 determines that the AP in use is an Agile Multiband-set AP, the processing proceeds to step S704. On the other hand, if the CPU 212 determines that the AP in use is not an Agile Multiband-set AP, the processing proceeds to step S702. Specifically, in step S701, the CPU 212 determines whether or not, at the previous startup (before the MFP 100 was shut down), the MFP 100 was connected to an AP based on a connection destination change request by the Agile Multiband function. In this embodiment, an AP based on a connection destination change request is called an “Agile Multiband-set AP” in some cases. In other words, an “Agile Multiband-set AP” is an AP connected to using the Agile Multiband function. As will be described later, the CPU 212 uses a flag to manage whether or not an Agile Multiband-set AP is in use. For example, when the MFP 100 connects to an Agile Multiband-set AP, the CPU 212 sets (switches ON) a flag to indicate that an Agile Multiband-set AP is the AP in use. Also, if the MFP 100 is connected to an AP other than an Agile Multiband-set AP, the CPU 212 removes (deletes) the flag set in the Agile Multiband-set AP. In step S701, the CPU 212 refers to a flag indicating that an Agile Multiband-set AP is in use, and if no flag has been set, the processing proceeds to step S702, and if a flag has been set, the processing proceeds to step S704. That is, in step S701, if the MFP 100 is shut down while connected to an Agile Multiband-set AP at the previous startup and then restarted, the processing proceeds to step S704. Note that the determination in step S701 may be made based on whether or not “Agile Multiband-set connection information”, which will be described later, is stored in the non-volatile memory 215, for example.

In step S702, control is performed to connect to a user-set AP. A user-set AP is not a connection-destination AP based on a connection destination change request by Agile Multiband, but an AP set as a connection-destination AP based on a user operation via the operation display unit 220 or the like. For example, the user can configure settings related to wireless connection from the menu screen of FIG. 3C described above. For example, the user can select an AP from a display screen listing identification information (SSIDs, etc.) of APs found through an AP search performed by the MFP 100, and input a password for the selected AP to set it as the connection-destination AP of the MFP 100. The identification information (SSID, BSSID, MAC address, etc.) and password set by the user are stored in the non-volatile memory 215 as connection information. In the following description, connection information such as the identification information (SSID, BSSID, MAC address, etc.) and password set by the user are referred to as “user-set connection information” in some cases. In this embodiment, the description will be given assuming that connection information with the AP 101 is set in the “user-set connection information”. That is, in this embodiment, in step S702, the CPU 212 performs control to attempt wireless connection to the AP 101. Note that in the following description, an AP connected to using “user-set connection information” is referred to as a “user-set AP” in some cases. In addition, the “user-set connection information” and the “Agile Multiband-set connection information” described later are stored separately in the non-volatile memory 215.

Note that in the present embodiment, the user-set connection information is set via the operation display unit 220, but there is no limitation to this. For example, information on the AP to which the mobile terminal device 104 is connected may be received from the mobile terminal device 104 connected to the MFP 100 and set. For example, if the mobile terminal device 104 supports a function called Wi-Fi Easy Connect (hereinafter, WEC) (registered trademark), the “user-set connection information” may be stored using this function. WEC is a function that executes network setup for another device using a Device Provisioning Protocol (hereinafter, DPP) developed by the Wi-Fi Alliance. Note that specifically, the network setup of another device is processing for connecting the other device to an access point that forms a network. In this way, the user may transmit connection information of the AP 101 of the MFP 100 from the mobile terminal device 104 using the WEC function. The user-set connection information may be set using a setting application or the like of the mobile terminal device 104. The user-set connection information may also be set using another setting method, such as using WPS (Wi-Fi Protected Setup) (registered trademark).

In step S703, the CPU 212 determines whether or not the connection to the user-set AP in step S702 succeeded. If the CPU 212 determines that the connection succeeded, the processing proceeds to step S708. On the other hand, if the CPU 212 determines that the connection failed, the processing proceeds to step S702. That is, in step S703, if the connection to the user-set AP failed, the CPU 212 once again attempts to connect to the same AP (step S702), and does not perform control to connect to the Agile Multiband-set AP. In this way, if the MFP 100 is shut down while connected to a user-set AP, the MFP 100 preferentially connects to the user-set AP. Note that, for example, if the distance between the user-set AP and the MFP 100 is not within a predetermined range, the MFP 100 may fail to connect to the user-set AP. In addition, for example, if the user-set AP is powered off or if the password for the AP input by the user is incorrect, the MFP 100 may fail to connect to the user-set AP.

In step S704, the CPU 212 performs control to execute connection to the “Agile Multiband-set AP”. An “Agile Multiband-set AP” is an AP that is connected to based on a connection destination change request by Agile Multiband. The connection destination change request includes, for example, connection information of an Agile Multiband connection destination, such as identification information of the AP after the change, information indicating the security method, and information such as the channel. Note that the identification information included in the change request is, for example, the SSID (BSSID, MAC address) or the like. Hereinafter, information such as the SSID (BSSID, MAC address) of the AP included in the connection destination change request stored by the MFP 100 may be referred to as “Agile Multiband-set connection information”. This Agile Multiband-set connection information is stored separately from the user-set connection information, as described above. In this embodiment, the Agile Multiband-set connection information will be described as the connection information of the AP 102. That is, in step S704, the CPU 212 performs control to attempt wireless connection to the AP 102 using the Agile Multiband connection information stored in the non-volatile memory 215.

In step S705, the CPU 212 determines whether or not connection to the Agile Multiband-set AP in step S704 succeeded. If the CPU 212 determines that the connection succeeded, the processing proceeds to step S708. On the other hand, if the CPU 212 determines that the connection failed, the processing proceeds to step S706. It should be noted that, for example, if the distance between the Agile Multiband-set AP and the MFP 100 is not within a predetermined range, or the like, the MFP 100 may fail to connect to the Agile Multiband-set AP. In addition, for example, if the Agile Multiband setting is powered off, or the like, the MFP 100 may fail to connect to the Agile Multiband-set AP.

In step S706, the CPU 212 performs control to connect to the user-set AP, similarly to the processing in step S702. In this way, even if connection to an Agile Multiband-set AP fails upon startup of the MFP 100, the MFP 100 attempts to connect to a user-set AP. This prevents the MFP 100 from becoming unconnected. Note that in this embodiment, a case will be described in which the processing of step S707 is performed after the processing of step S706, but there is no limitation to this. For example, after executing the processing of step S706, the CPU 212 may perform the same processing as step S703. That is, after executing the processing of step S706, the CPU 212 may determine whether or not the connection to the user-set AP succeeded. In addition, if the CPU 212 determines that the connection to the user-set AP failed, the CPU 212 may repeat the processing of step S706.

In step S707, the CPU 212 removes the Agile Multiband-set AP from the AP currently in use. Specifically, the CPU 212 deletes (removes) a flag set in the Agile Multiband-set AP. In step S707, for example, the CPU 212 may delete the Agile Multiband-set connection information stored in the non-volatile memory 215.

In step S708, the CPU 212 determines whether or not an inquiry (measurement request) about the radio wave strengths of APs in the surrounding area of the MFP 100 has been received from a connected AP. The connected AP may be, for example, the AP 101 if connection to a user-set AP succeeds in step S702 or S706, or may be the AP 102 if connection to an Agile Multiband-set AP succeeds in step S704. This inquiry is transmitted as a beacon frame request or a beacon report request. An inquiry about radio wave strength that is received and confirmed in this step corresponds to the inquiry transmitted by the AP 101 in step S601 of FIG. 6. If the CPU 212 determines that an inquiry about radio wave strength has been received, the processing proceeds to step S709. On the other hand, if the CPU 212 determines that it has not received an inquiry about radio wave strength, the processing proceeds to step S710.

In step S709, as described in steps S602 and S603 of FIG. 6, the CPU 212 measures the radio wave strengths of the APs in the surrounding area of the MFP 100, and transmits a list of the radio wave strengths of the APs as a Beacon report to the connected AP.

In step S710, it is determined whether or not a connection destination change request for the MFP 100 has been received from the connected AP. This processing corresponds to the determination of whether or not a request has been received in step S605 of FIG. 6 described above. This request includes information on the SSID, channel, and frequency band of the other AP designated as the switching destination, as described above, and the like. If the CPU 212 determines that a connection destination change request has been received, the processing proceeds to step S711. On the other hand, if the CPU 212 determines that a connection destination change request has not been received, the processing proceeds to step S717.

In step S711, the CPU 212 transmits a response indicating approval of the switch to the currently connected AP. This processing corresponds to step S605 in FIG. 6 described above.

In step S712, the CPU 212 terminates the connection of the currently connected AP in accordance with the received connection destination change request (corresponding to the processing of step S607 in FIG. 6), and attempts to connect by transmitting a connection request to the recommended AP included in the connection destination change request (corresponding to the processing of step S608 in FIG. 6).

In step S713, the CPU 212 determines whether or not connection to the recommended AP based on the change request succeeded. If the CPU 212 determines that the connection succeeded, the processing proceeds to step S714. On the other hand, if the CPU 212 determines that the connection did not succeed, the processing proceeds to step S716. That is, if the connection has failed, the CPU 212 proceeds to step S716.

In step S714, the CPU 212 performs recording control for performing control to store, in the non-volatile memory 215, information about the AP connected to in step S712 (the recommended AP that was included in the change request and was successfully connected to). For example, if the CPU 212 is connected to the AP 101 set by the user and is able to change the connection-destination AP to the AP 102 based on a connection destination change request, the CPU 212 stores the connection information of AP 102 in the non-volatile memory 215 as an Agile Multiband-set AP.

In step S715, the CPU 212 stores information indicating that an Agile Multiband-set AP is being used as the connection-destination AP. Specifically, the CPU 212 sets a flag to indicate that an Agile Multiband-set AP is the AP in use, and stores the flag in the non-volatile memory 215, for example. This flag is used in the determination in step S701 described above when the MFP 100 is restarted.

In step S716, the CPU 212 connects to the AP using user-set connection information, which is connection information set in advance by the user. For example, if the MFP 100 receives a connection destination change request from the AP 101 while connected to the AP 101 set by the user, the MFP 100 will attempt to disconnect from the AP 101 in accordance with the change request and change the connection-destination AP to the AP 102. That is, the MFP 100 performs control for connecting to the AP 102. However, if the MFP 100 fails to connect to the AP 102 as a result, it will reconnect to the AP 101 based on the “user-set connection information” recorded in the non-volatile memory 215. This makes it possible to prevent the MFP 100 from becoming unconnected from the AP. In addition, in this embodiment, a case where the processing of step S717 is performed after the processing of step S716 will be described, but there is no limitation to this. For example, after executing the processing of step S716, the CPU 212 may perform the same processing as step S703. That is, after executing the processing of step S716, the CPU 212 may determine whether or not connection to the user-set AP succeeded. In addition, if the CPU 212 determines that the connection to the user-set AP failed, the CPU 212 may repeat the processing of step S716.

In step S717, the CPU 212 determines whether or not the user has started wireless LAN settings. If the CPU 212 determines that the user has started wireless LAN settings, the processing proceeds to step S718. On the other hand, if the CPU 212 determines that the user has not started wireless LAN settings, the processing proceeds to step S718. This is a determination as to whether or not the user has performed an operation to set the AP (wireless LAN) connection destination of the MFP 100, as described above. For example, when the user operates the operation display unit 220 and selects wireless LAN on the screen of FIG. 3C, the CPU 212 may determine that the user has started wireless LAN settings. Note that the case where it is determined that the user has started wireless LAN settings is not limited to this. For example, when it is accepted that the user has started wireless LAN settings using a setting application for the MFP 100 installed on the mobile terminal device 104, the CPU 212 may determine that the user has started wireless LAN settings. For example, there may be a case where the MFP 100 operates as a Hypertext Transfer Protocol (hereinafter, HTTP) server, and wireless LAN settings of the MFP 100 can be executed on the mobile terminal device 104 via a web browser. For example, when it is accepted that a web page on which wireless LAN settings can be executed has been opened from a web browser, the CPU 212 may determine that the user has started wireless LAN settings.

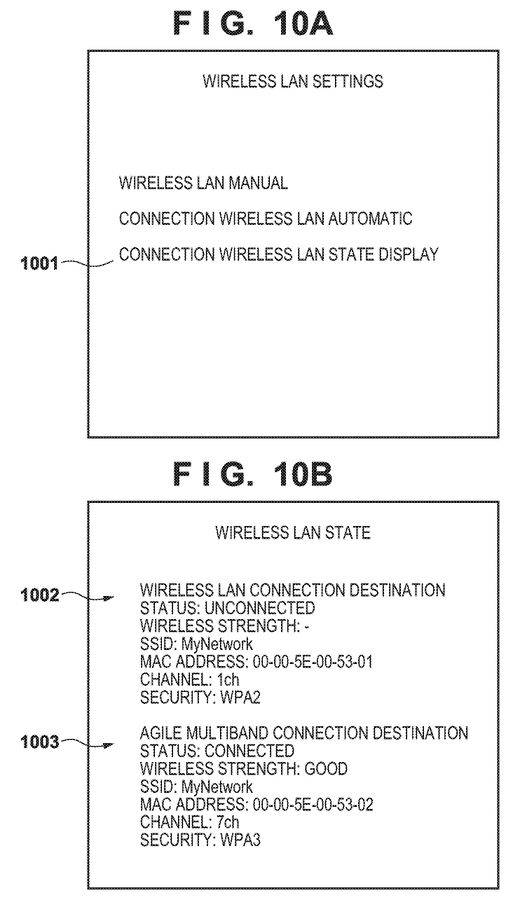

In step S718, the CPU 212 displays an interface that can accept an instruction to set the connection-destination AP of the MFP 100. Specifically, for example, when the user operates the operation display unit 220, the CPU 212 may display a wireless LAN setting screen (e.g., FIG. 10A, which will be described later) on the operation display unit 220. In addition, if the user has configured wireless settings using a setting application on the mobile terminal device 104, the wireless LAN setting screen may be displayed by the setting application. For example, the CPU 212 may perform control such as instructing the setting application to display a wireless LAN setting screen. In addition, when a web page on which settings of the MFP 100 can be configured is displayed from a web browser on the mobile terminal device 104, the CPU 212 may transmit HTTP data of a wireless LAN setting screen.

In step S719, the CPU 212 performs recording control in which control is performed to store the connection information of the AP for which the user operation on the wireless LAN setting screen displayed in step S718 has been accepted, in the non-volatile memory 215 as the user-set connection information. The AP connection information input based on a user operation includes, for example, identification information (e.g., SSID (BSSID, MAC address)) and authentication information (e.g., password) of the connection-destination AP.

In step S720, the CPU 212 performs control to connect to the AP using the user-set connection information that was stored in the non-volatile memory 215 in step S719.

In step S721, the CPU 212 determines whether or not connection to the user-set AP in step S720 succeeded. If the CPU 212 determines that the connection succeeded, the processing proceeds to step S722. On the other hand, if the CPU 212 determines that the connection failed, the processing proceeds to step S720. That is, even if the wireless connection in step S720 fails, the CPU 212 does not perform control to connect to the connection-destination AP stored as the Agile Multiband-set connection information.

In step S722, the CPU 212 turns off (deletes) the in-use flag, which is information indicating being connected to the connection-destination AP that has been changed by the Agile Multiband function. Note that in step S722, for example, the CPU 212 may delete the Agile Multiband-set connection information stored in the non-volatile memory 215.

In this way, in steps S711 to S716, when the connection destination is changed based on a connection destination change request from an AP, if the CPU 212 attempts to connect to the changed connection-destination AP (recommended AP) and fails, the CPU 212 performs control to connect to the user-set AP. On the other hand, in steps S718 to S722, if the CPU 212 attempts to connect to the user-set AP and fails, the CPU 212 does not perform connection processing to a connection destination other than the user-set AP, but retries connecting to the user-set AP.

In step S723, the CPU 212 determines whether or not there is another event. If the CPU 212 determines that there is another event, the processing proceeds to step S724. On the other hand, if the CPU 212 determines that there is no other event, the processing proceeds to step S725. The other event may be, for example, an instruction to scan a document using the reading unit 219, an instruction to copy, an instruction to print (print out) in the printing unit 222, or the like. In step S723, the CPU 212 may determine whether or not such an instruction has been accepted. In step S724, the CPU 212 performs processing corresponding to the event according to which it was determined that there is another event in step S723.

In step S725, the CPU 212 determines whether or not the connection with the AP has ended. If the CPU 212 determines that the connection with the AP has ended, the CPU 212 ends the processing of FIGS. 7A and 7B. On the other hand, if the CPU 212 determines that the connection with the AP has not ended, the processing proceeds to step S708. Specifically, for example, the CPU 212 may determine that the connection has ended when the MFP 100 is shut down, when the wireless settings of the MFP 100 are switched, from a screen or the like, to settings that disable the wireless connection, or the like. In addition, for example, the CPU 212 may determine that the connection has ended when the connection is terminated from the currently connected AP, when wireless radio waves are no longer received, or the like.

As described above, according to this embodiment, the MFP 100 stores connection information of APs set by the user and connection information of APs based on a connection destination change request. Even if the MFP 100 receives a connection destination change request from the currently connected AP and fails to connect to the connection-destination AP based on the request, it can return the connection destination to the AP to which it was originally connected using stored connection information set by the user. This makes it possible to prevent the MFP 100 from becoming unconnected from the AP even if the MFP 100 fails to switch the connection. Accordingly, it is possible to improve the convenience when an STA connects to an AP.

Note that in this embodiment, an example has been described in which a change request is received in step S710, and if connection to a recommended AP based on the received change request fails when an attempt is made to connect to the recommended AP (NO in step S713), then in step S716, connection to the AP is performed using the user-set connection information. However, there is no limitation to this, and if connection to a recommended AP succeeds based on a change request (YES in step S713), and communication is subsequently established through the connection with the recommended AP, and then the connection with the recommended AP is terminated for some reason, control may be performed such that the processing of step S716 is performed. That is, if communication is being performed with the connection destination changed using the Agile Multiband function, but the connection with the changed connection destination is lost, the AP 101 set by the user may be connected to.

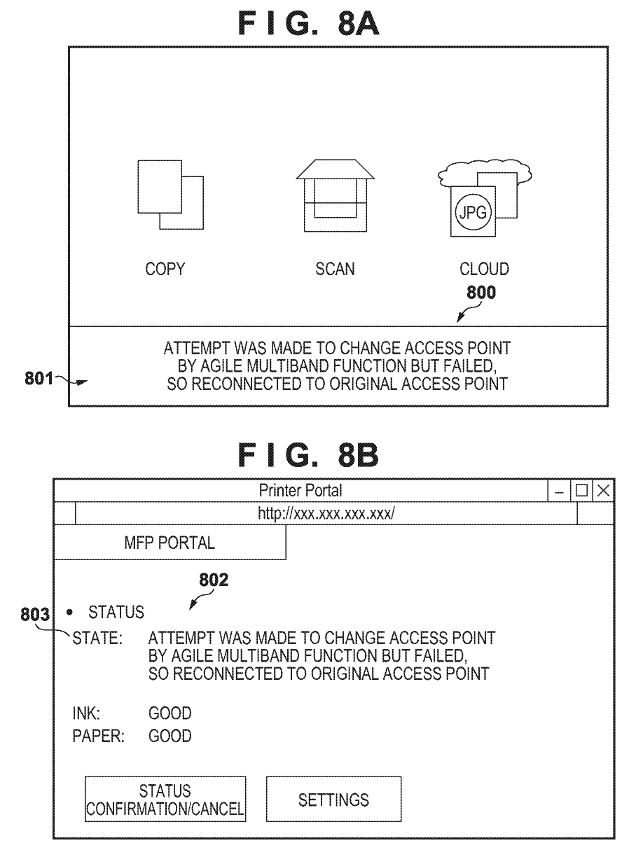

Note that in the present embodiment, an example has been described in which, when connection using the Agile Multiband function fails, the CPU 212 performs control to change the connection-destination AP to a user-set AP. At this time, for example, if the connection using the Agile Multiband function fails, the CPU 212 may notify the user that the connection using the Agile Multiband function has failed, or may notify the user that the original connection destination was connected to. Notification in the case where connection fails due to the Agile Multiband function will be described with reference to FIGS. 8A and 8B. FIG. 8A shows an example of a screen displayed on the operation display unit 220 of the MFP 100. A notification display unit 800 may be displayed on the home screen of the operation display unit 220. The notification display unit 800 is an interface that can display predetermined notifications. For example, if the MFP 100 fails to connect using the Agile Multiband function, the notification display unit 800 displays a notification 801 indicating that switching of the connection-destination AP using the Agile Multiband function has failed and that the MFP 100 has connected to the original connection destination. For example, after executing the processing of step S716 described above, the CPU 212 may execute processing for issuing the notification 801, or may perform display control for displaying the notification 801 on the operation display unit 220. Also, although FIG. 8A shows an example in which the notification 801 is displayed on the notification display unit 800 on the home screen, the notification 801 may also be displayed on the mobile terminal device 104 or the like.

FIG. 8B will be referred to. FIG. 8B shows an example of a screen displayed on the display unit 420 of the mobile terminal device 104. In some cases, the MFP 100 operates as an HTTP server, and various settings and states of the MFP 100 can be operated via a web browser on the mobile terminal device 104. The screen in FIG. 8B is displayed when, for example, a user accesses a predetermined web page from a web browser that allows the user to operate various settings and states of the MFP 100.

The screen in FIG. 8B may display a status display unit 802, a status confirmation/cancel button, a setting button, and the like. The status display unit 802 may display, for example, the connection state of the MFP 100, the remaining amounts of ink and paper, and the like. If the MFP 100 fails to connect using the Agile Multiband function, the status display unit 802 may display the notification 801 indicating that switching of the connection-destination AP using the Agile Multiband function has failed, or that the MFP 100 has connected to the original connection destination. For example, the CPU 212 may perform processing for issuing the notification 801 after executing the processing of step S716 described above. The status confirmation/cancel button may be, for example, an interface capable of accepting an instruction to display a detailed screen (not shown) of the job status of the MFP 100, or an interface capable of accepting an instruction to cancel a job being executed by the MFP 100. The setting button may be, for example, an interface capable of accepting an instruction to display a screen (not shown) on which various settings such as communication settings and print settings of the MFP 100 can be executed. Due to the notification 801 being issued in this manner, the user can recognize that the MFP 100 has failed to change the AP using the Agile Multiband function and has reconnected to the original AP.

In addition, the notification 801 is not limited to the examples shown in FIGS. 8A and 8B. For example, the notification 801 may be issued by audio from a speaker unit (not shown) of the MFP 100 or the speaker unit 424 of the mobile terminal device 104. This allows the user to recognize that the MFP 100 has failed to change the AP connection and that the MFP 100 has been connected to the original AP, even if the user is not looking at the MFP 100. Also, for example, the notification 801 may be issued due to the printing unit 222 of the MFP 100 printing a report. Even in this case, the user can recognize that the MFP 100 has failed to change the AP connection and that it has been connected to the original AP. In addition, in FIG. 8A, an example has been described in which the notification display unit 800 is displayed at the bottom of the home screen, but there is no limitation to this. For example, the notification 801 may be displayed in the center or at the top of the home screen.

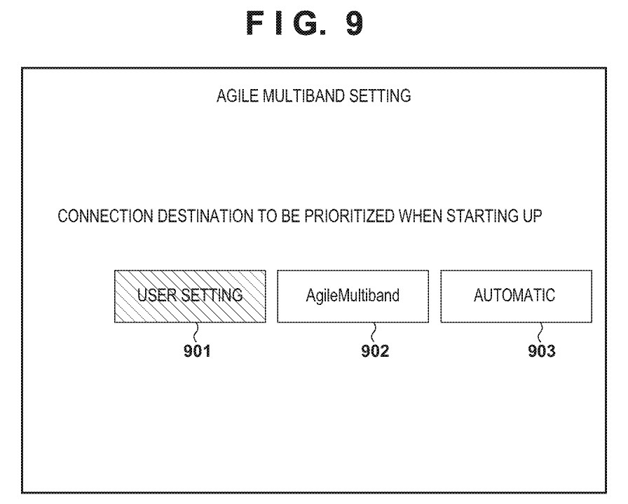

Note that in the present embodiment, in the processing of step S701, an example has been described in which the CPU 212 determines whether or not the MFP 100 was connected to an Agile Multiband-set AP at the previous startup (before the MFP 100 was powered off), but there is no limitation to this. For example, the connection-destination AP when the MFP 100 is powered on may be determined based on a user setting. The following description will be given with reference to FIG. 9.

FIG. 9 shows an example of a screen on which the connection-destination AP when the MFP 100 is started up can be set. The screen in FIG. 9 displays, for example, interfaces 901 to 903 that can accept instructions for setting the connection-destination AP when the MFP 100 is started up. User setting 901 is an interface that can accept a setting instruction to set the connection-destination AP when the MFP 100 is started up to the user-set AP, for example. For example, when the user presses “user setting 901”, the CPU 212 may store, in a memory such as the non-volatile memory 215, a setting for attempting to connect to the user-set AP when the MFP 100 is started up. If “user setting 901” is selected, the CPU 212 attempts to connect to the user-set AP when the MFP 100 is restarted, regardless of whether or not the MFP 100 was connected to another AP using the Agile Multiband function at the previous startup. That is, the processing of step S701 in FIG. 7A may be skipped, and the processing may start from step S702.

Agile Multiband 902 is an interface that can accept a setting instruction to set the connection-destination AP when the MFP 100 is started up to an Agile Multiband-set AP, for example. When the user presses “Agile Multiband setting 902”, for example, the CPU 212 may store, in a memory such as the non-volatile memory 215, a setting that sets the connection-destination AP when the MFP 100 is started up to an Agile Multiband-set AP. If set in this way, the CPU 212 attempts to connect to an Agile Multiband-set AP when the MFP 100 is restarted, regardless of whether or not the MFP 100 was connected to another AP with the Agile Multiband function at the previous startup. That is, the processing of step S701 in FIG. 7A may be skipped, and the processing may be started from step S704. In this way, by allowing the user to set the connection-destination AP when the MFP 100 is started up, it is possible to prevent the MFP 100 from being connected to an AP that is not intended by the user. Accordingly, it is possible to improve the convenience when connecting the MFP 100 to an AP.

Automatic 903 is an interface that can accept an instruction for configuring a setting by which the connection-destination AP when the MFP 100 is started up is automatically determined, for example. When the user presses “automatic 903”, for example, the CPU 212 may store, in a memory such as the non-volatile memory 215, a setting that sets the connection-destination AP when the MFP 100 is started up to an AP based on radio wave strength. In this case, for example, the CPU 212 may execute processing for measuring radio wave strengths of APs in the surrounding area of the MFP 100 when the MFP 100 is started up. The CPU 212 may perform control such that the MFP 100 is connected to an AP with high radio wave strength among the APs in the surrounding area of the MFP 100. That is, instead of step S701, an AP search may be performed, and processing may be performed to determine an AP with a high radio wave strength from among the user-set AP and the Agile Multiband-set AP. If the CPU 212 determines that the radio wave strength of the user-set AP is stronger than that of the Agile Multiband-set AP, the processing may proceed to step S702. On the other hand, if the CPU 212 determines that the radio wave strength of the Agile Multiband-set AP is stronger than that of the user-set AP, the processing may proceed to step S704. In this way, when the MFP 100 is started up, it is controlled to connect to the AP that has better conditions, including stronger radio wave strength, between the user-set AP and the Agile Multiband-set AP, thereby improving the convenience when the MFP 100 connects to an AP.

In addition, the connection information of the user-set AP and the connection information of the Agile Multiband-set AP may be displayed on a wireless LAN setting screen or the like. FIGS. 10A and 10B will be referred to. FIG. 10A is an example of a UI display in the case where, for example, “wireless LAN” in FIG. 3C is selected by the user. FIG. 10A shows, for example, a screen that can accept instructions for wireless LAN settings from the user. The screen of FIG. 10A may display, for example, an interface capable of manually (by user operation) receiving an instruction to set the connection-destination AP of the MFP 100, or an interface capable of automatically receiving an instruction to set the connection-destination AP of the MFP 100. The screen of FIG. 10A may also display an interface 1001 that can accept an instruction to display the connection state of an AP to which the MFP 100 has connected before or an AP to which the MFP 100 is currently connected.

For example, when the user selects “wireless LAN state display 1001” in FIG. 10A, the CPU 212 may perform display control to display the screen in FIG. 10B. FIG. 10B is an example of a screen showing the connection states of APs to which MFP 100 has connected before and APs to which MFP 100 is currently connected. In other words, FIG. 10B can be said to be a screen that displays connection states of APs stored in the MFP 100. That is, the CPU 212 may perform display control in which control is performed to display state information indicating the connection state between the MFP 100 and each of the user-set AP and the Agile Multiband-set AP. The screen in FIG. 10B displays “wireless LAN connection destination 1002”, “Agile Multiband connection destination 1003”, and the like. “Wireless LAN connection destination 1002” displays the connection information of the user-set AP. “Aglie Multibund connection destination 1003” displays the connection information of the Agile Multiband-set AP. “Wireless LAN connection destination 1002” and “Aglie Multibund connection destination 1003” include, for example, information indicating whether or not each AP is currently connected to the MFP 100 in the status field. In addition, if the AP is currently connected to the MFP 100, information indicating the wireless strength (e.g., radio wave strength) is displayed. The information indicating the wireless strength may be displayed in three levels, for example, “good”, “normal”, and “poor”. Note that the information indicating the wireless strength may be displayed as a percentage, for example. The SSID, MAC address, channel, security method, and the like of the AP may also be displayed. This allows the user to check the connection state between the MFP 100 and a user-set AP or an Agile Multiband-set AP, and to specify the AP connected to the MFP 100.

As another example, while connected to the AP 102 using the Agile Multiband function, the MFP 100 may receive a request to connect to an AP 3 (not shown) from the AP 102. In this case, for example, the CPU 212 may perform control to change the connection-destination AP of the MFP 100 to the AP 3 (not shown) in accordance with a connection destination change request received from the AP 102. In addition, if the connection to the AP 3 fails, the CPU 212 may reconnect to the AP 101, which is the user-set AP, or may reconnect to AP 102, which was previously connected. For example, when the CPU 212 attempts to connect to the AP 101 after failing to connect to the AP 3, the CPU 212 operates in the same manner as in FIGS. 7A and 7B. That is, the CPU 212 may attempt to connect to the AP 3 in the processing of step S711 to S712, and if it determines that the connection failed (NO in step S713), it may attempt to connect to the AP 101, which is the user-set AP, in step S716. On the other hand, when connecting to the AP 102 after failing to connect to the AP 3, the CPU 212 executes an operation different from the processing in FIGS. 7A and 7B. That is, if the connection to the AP 3 fails (NO in step S713), the CPU 212 may attempt to connect to the AP 2 using the connection information of the AP 102 stored in the non-volatile memory 215 instead of step S716. Even in this configuration, if the MFP 100 fails to connect to the AP, it is possible to prevent the MFP 100 from becoming unconnected from the AP. Accordingly, it is possible to improve the convenience when connecting the MFP 100 to an AP.

Note that the various controls described above as being performed by the CPU 212 may be performed by a single piece of hardware, or the entire device may be controlled by a plurality of pieces of hardware (e.g., a plurality of processors or circuits) sharing the processing.

Also, although the present disclosure has been described in detail based on its preferred embodiments, the present disclosure is not limited to these specific embodiments, and various modes that do not deviate from the gist of the disclosure are also included in the present disclosure. Furthermore, the above-described embodiments merely represent one embodiment of the present disclosure, and the embodiments can be combined as appropriate.

Furthermore, in the above-described embodiment, the present disclosure has been described as being applied to an MFP, but this is not limited to this example and can be applied to any wireless device that connects to an AP, functions as an STA, and is capable of security settings. That is, the present disclosure is applicable to personal computers, PDAs, tablet terminals, mobile phone devices such as smartphones, music players, game consoles, e-book readers, smart watches, and various measurement devices (sensor devices) such as thermometers and hygrometers. The present disclosure is also applicable to digital cameras (including still cameras, video cameras, network cameras, and security cameras), printers, scanners, and drones. The present disclosure is also applicable to video output devices, audio output devices (e.g., smart speakers), media streaming players, wireless LAN clients (adapters) that can be connected to USB terminals or LAN cable terminals, and the like. Video output devices include devices that, for example, acquire (download) videos from the Internet that are specified by a URL designated by an electronic device and output them to a connected display device via a video output terminal such as HDMI (trademark), thereby enabling streaming playback on the display device or mirroring display (displaying the content displayed on the electronic device on the display device as well). In addition, video output devices include media players such as televisions, hard disk recorders, Blu-ray recorders, and DVD recorders, head-mounted displays, projectors, televisions, display devices (monitors), signage devices, and the like. The present disclosure is also applicable to Wi-Fi connectable devices known as smart home appliances, such as air conditioners, refrigerators, washing machines, vacuum cleaners, ovens, microwave ovens, lighting appliances, heating appliances, and cooling appliances.

According to the present disclosure, it is possible to improve the convenience when an STA connects to an AP.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic device comprising:
at least one memory and at least one processor which function as:
a change unit configured to perform control to change a connection destination from a currently connected access point to another access point based on a change request to change an access point serving as a connection destination, the change request being received from the currently connected access point;
a recording control unit configured to perform control to record, in storage unit, first connection information that is information for connecting to a first access point set in advance without dependence on the change request, and second connection information that is information for connecting to a second access point based on the change request; and
a control unit configured to,
if control for connecting to the first access point is performed and connection to the first access point fails, refraining from performing control to connect to another access point, and
if connection to an access point that is a connection destination based on the change request fails, performing control to connect to the first access point using the first connection information.

2. The electronic device according to claim 1,
wherein when the electronic device is started up after the electronic device is shut down while connected to the second access point based on the change request, if control for connecting to the second access point using the second connection information stored in the storage unit is performed and connection to the second access point fails, the control unit performs control to connect to the first access point using the first connection information.

3. The electronic device according to claim 1,
wherein the at least one memory and the at least one processor further function as:
a setting unit configured to be capable of setting an access point to be connected to when the electronic device is started up,
wherein if the setting unit has set the first access point as the access point to be connected to when the electronic device is started up, the control unit performs control to connect to the first access point when the electronic device is started up, and
if the setting unit has set the second access point as the access point to be connected to when the electronic device is started up, the control unit performs control to connect to the second access point when the electronic device is started up.

4. The electronic device according to claim 3,
wherein if the setting of the access point to be connected to when the electronic device is started up by the setting unit is a setting to automatically determine an access point to be connected to,
the control unit performs control to connect to an access point having a better condition including stronger radio wave strength, out of the first access point and the second access point when the electronic device is started up.

5. An electronic device comprising:
at least one memory and at least one processor which function as:
a change unit configured to perform control to change a connection destination from a currently connected access point to another access point based on a change request to change an access point serving as a connection destination, the change request being received from the currently connected access point; and
a control unit configured to
perform control to connect to a first access point set in advance without dependence on the change request when the electronic device is started up,
if control for connecting to the first access point is performed and connection to the first access point fails, refraining from performing control to connect to another access point different from the first access point, and
if control for connecting to a second access point that is different from the first access point and is a connection destination based on the change request is performed and connection to the second access point fails, performing control to connect to the first access point.

6. The electronic device according to claim 1,
wherein the at least one memory and the at least one processor further function as:
a notification unit configured to, if control is performed to change the connection from the first access point to the second access point based on the change request and the change of the connection to the second access point fails, perform control to perform notification of the failure.

7. The electronic device according to claim 6,
wherein after the failure, if connection to the first access point is established using the first connection information under the control of the control unit, the notification unit performs notification that connection to the first access point was established.

8. The electronic device according to claim 1,
wherein after the change of connection from the first access point to the second access point based on the change request succeeds, if a second change request prompting a change of connection destination to a third access point is further received from the currently connected second access point,
the change unit performs control to connect to the third access point based on the second change request, and
if connection to the third access point based on the second change request fails, the control unit performs control to connect to the first access point based on the first connection information stored in the storage unit.

9. The electronic device according to claim 1,
wherein after the change of connection from the first access point to the second access point based on the change request succeeds, if a second change request prompting a change of connection destination to a third access point is further received from the currently connected second access point,
the change unit performs control to connect to the third access point based on the second change request, and
if connection to the third access point based on the second change request fails, the control unit performs control to connect to the second access point based on the second connection information stored in the storage unit.

10. The electronic device according to claim 1,
wherein the at least one memory and the at least one processor further function as:
a display control unit configured to perform control to display state information indicating a connection state of each of the first access point and the second access point with the electronic device.

11. The electronic device according to claim 10,
wherein the state information includes at least one of information indicating whether or not the first access point and the second access point are each connected to the electronic device, and information indicating a radio wave strength of each of the first access point and the second access point.

12. The electronic device according to claim 1,
wherein the at least one memory and the at least one processor further function as:
an accepting unit configured to accept input of connection information for connection to the access point from a user,
wherein the first connection information is information accepted by the accepting unit.

13. The electronic device according to claim 1,
wherein the electronic device performs connection and processing with respect to an access point in accordance with the IEEE 802.11ax standard.

14. The electronic device according to claim 1,
wherein the electronic device can perform at least one of processing conforming to Orthogonal Frequency-Division Multiple Access (OFDMA) and processing conforming to Target Wake Time (TWT).

15. The electronic device according to claim 1,
wherein the electronic device can change a connection destination to an AP in a 6 GHz band by changing the connection destination based on the change request.

16. The electronic device according to claim 1, further comprising:
a printer configured to print an image on a printing medium.

17. A control method for an electronic device, comprising:
performing control to change a connection destination from a currently connected access point to another access point based on a change request to change an access point serving as a connection destination, the change request being received from the currently connected access point;
performing control to record, in a storage unit, first connection information that is information for connecting to a first access point set in advance without dependence on the change request, and second connection information that is information for connecting to a second access point based on the change request; and
controlling to:
if control for connecting to the first access point is performed and connection to the first access point fails, refrain from performing control to connect to another access point, and
if connection to an access point that is a connection destination based on the change request fails, perform control to connect to the first access point using the first connection information.

18. A control method for an electronic device, comprising:
performing control to change a connection destination from a currently connected access point to another access point based on a change request to change an access point serving as a connection destination, the change request being received from the currently connected access point; and
controlling to:
perform control to connect to a first access point set in advance without dependence on the change request when the electronic device is started up,
if control for connecting to the first access point is performed and connection to the first access point fails, refrain from performing control to connect to another access point different from the first access point, and
if control for connecting to a second access point that is different from the first access point and is a connection destination based on the change request is performed and connection to the second access point fails, perform control to connect to the first access point.

19. A non-transitory computer-readable storage medium storing a program configured to cause a computer of an electronic device to function as:
a change unit configured to perform control to change a connection destination from a currently connected access point to another access point based on a change request to change an access point serving as a connection destination, the change request being received from the currently connected access point;
a recording control unit configured to perform control to record, in storage unit, first connection information that is information for connecting to a first access point set in advance without dependence on the change request, and second connection information that is information for connecting to a second access point based on the change request; and
a control unit configured to,
if control for connecting to the first access point is performed and connection to the first access point fails, refraining from performing control to connect to another access point, and
if connection to an access point that is a connection destination based on the change request fails, performing control to connect to the first access point using the first connection information.

20. A non-transitory computer-readable storage medium storing a program configured to cause a computer of an electronic device to function as:
a change unit configured to perform control to change a connection destination from a currently connected access point to another access point based on a change request to change an access point serving as a connection destination, the change request being received from the currently connected access point; and
a control unit configured to
perform control to connect to a first access point set in advance without dependence on the change request when the electronic device is started up,
if control for connecting to the first access point is performed and connection to the first access point fails, refraining from performing control to connect to another access point different from the first access point, and
if control for connecting to a second access point that is different from the first access point and is a connection destination based on the change request is performed and connection to the second access point fails, performing control to connect to the first access point.
